(19) United States
(12) Patent Application Publication
(10) Pub. No.: US 2026/0229542 A1
(43) Pub. Date: Aug. 6, 2026

(54) ANODE-FREE LITHIUM METAL BATTERIES FORMED BY ATOMIC AND MOLECULAR LAYER DEPOSITION

(71) Applicant: BOARD OF TRUSTEES OF THE UNIVERSTIY OF ARKANSAS, Little Rock, AR (US)

(72) Inventors: Xiangbo Meng, Fayetteville, AR (US); Aiying Shao, Fayetteville, AR (US)

(73) Assignee: BOARD OF TRUSTEES OF THE UNIVERSTIY OF ARKANSAS, Little Rock, AR (US)

(21) Appl. No.: 19/128,185

(22) PCT Filed: Nov. 7, 2023
(86) PCT No.: PCT/US2023/036958

§ 371 Date: May 8, 2025

Related U.S. Application Data
(60) Provisional application No. 63/423,630, filed on Nov. 8, 2022.

(51) Int. Cl. H01M 4/66; H01M 4/04; H01M 10/0525; H01M 10/42

(52) U.S. Cl. CPC H01M 4/667; H01M 4/0404; H01M 4/0428; H01M 4/661; H01M 4/668; H01M 10/0525; H01M 10/4235

(57) ABSTRACT

In some embodiments, the present disclosure pertains to an energy storage device with an anode current collector that includes a surface coating of a lithium metal sulfide, a lithium-containing alkoxide polymer, or combinations thereof. Additional embodiments of the present disclosure pertain to methods of making an energy storage device by depositing a surface coating of the present disclosure on an anode current collector of the energy storage device. In some embodiments, the methods of the present disclosure also include a step of incorporating the anode current collector into the energy storage device.

### CROSS-REFERENCE TO RELATED APPLICATIONS

This application claims priority to U.S. provisional patent application No. 63/423,630, filed on Nov. 8, 2022. The entirety of the aforementioned application is incorporated herein by reference.

### BACKGROUND

A need exists for improved current collectors with improved electrochemical performance of batteries. Numerous embodiments of the present disclosure address the aforementioned need.

### SUMMARY

In some embodiments, the present disclosure pertains to an energy storage device with an anode current collector that includes a surface coating of a lithium metal sulfide, a lithium-containing alkoxide polymer, or combinations thereof. Additional embodiments of the present disclosure pertain to methods of making an energy storage device by depositing a surface coating of the present disclosure on an anode current collector of the energy storage device. In some embodiments, the methods of the present disclosure also include a step of incorporating the anode current collector into the energy storage device.

The methods of the present disclosure may utilize various processes to deposit surface coatings on anode current collectors. For instance, in some embodiments, the surface coating is deposited by a method that includes, without limitation, atomic layer deposition (ALD), molecular layer deposition (MLD), or combinations thereof.

In some embodiments, the anode current collector surface coating includes lithium metal sulfide. In some embodiments, the lithium metal sulfide includes the formula LixMyS, where M is a metal, and where x and y are each a decimal number or an integer number of more than 0.

In some embodiments, the anode current collector surface coating includes a lithium-containing alkoxide polymer. In some embodiments, the lithium-containing alkoxide polymer includes the following formula: —Li—O—R—O—Li—, where R is a carbon-containing compound.

The energy storage devices of the present disclosure may be in various forms. For instance, in some embodiments, the energy storage device is an anode-free energy storage device. In some embodiments, the energy storage device is a battery. In some embodiments, the energy storage device is a lithium-ion battery. In some embodiments, the energy storage device is a lithium metal battery. In some embodiments, the energy storage device is an anode-free lithium metal battery.

### DESCRIPTION OF THE DRAWINGS

FIG. 1 provides an illustration of an energy storage device in accordance with various embodiments of the present disclosure.

FIG. 2 provides a schematic illustration of an anode-free lithium metal battery (AF-LMBs) in accordance with various embodiments of the present disclosure.

FIGS. 3A-3B provide schematic illustrations of AF-LMBs during charge (FIG. 3A) and discharge (FIG. 3B).

FIG. 4 provides a schematic illustration of a general super-atomic layer deposition (ALD) strategy for growing an Li-containing lithium metal sulfide (LiₓM_{y}S, M=metal) as a superionic conductor coating via ALD, which combines two sub-ALD processes of lithium sulfide (Li₂S) and a metal sulfide.

FIG. 5 provides a schematic illustration of a general molecular layer deposition (MLD) process for growing an Li-containing homo-alkoxide using an Li precursor and an organic precursor.

FIG. 6 provides a schematic illustration of a general super-MLD process for growing a Li-containing co-alkoxide through combining two or more sub-MLD processes of Li-containing homo-alkoxides.

FIGS. 7A-7D illustrate electrochemical performance of bare Cu∥NMC811 (FIGS. 7A, 7C and 7D) and LiGL400-Cu∥NMC811 AF-LMB cells (FIGS. 7B, 7C and 7D) in the carbonate electrolyte (1.2 M LiPF₆ in 3:7 w/w EC: EMC), showing that the MLD LiGL coating dramatically improved the sustainable capacity and Coulombic efficiency of the LiGL400-Cu∥NMC811 cell in the voltage window of 3.0-4.3 V at the current density of 0.2 C (1 C=200 mA/g). Shown are the charge-discharge profiles in the first 5 cycles of bare Cu∥NMC811 (FIG. 7A) and LiGL400-Cu∥NMC811 (FIG. 7B). FIG. 7C shows the sustainable capacity of bare Cu∥NMC811 and LiGL400-Cu∥NMC811 cells with cycling, showing that the LiGL400-Cu∥NMC811 enabled much higher capacities than those of the bare Cu|INMC81 cell. FIG. 7D shows the Coulombic efficiency of bare Cu∥NMC811 and LiGL400-Cu∥NMC811 cells with cycling, showing that the LiGL400-Cu∥NMC811 enabled much higher Coulombic efficiencies than those of the bare Cu∥NMC81 cell. LiGL400 indicates 400 MLD cycles of LiGL.

FIGS. 8A-8D illustrate the electrochemical performance of bare Cu∥NMC811 (FIGS. 8A, 8C, and 8D) and LiGL400-Cu∥NMC811 (FIGS. 8B, 8C, and 8D) AF-LMB cells in the ether electrolyte (1 M LiTFSI in 1:1 v/v DOL:DME), showing that the MLD LiGL coating dramatically improved the sustainable capacity and Coulombic efficiency of the LiGL400-Cu∥NMC811 cell in the voltage window of 3.0-4.3 V at the current density of 0.2 C (1 C=200 mA/g). Shown are the charge-discharge profiles in the first 5 cycles of bare Cu∥NMC811 (FIG. 8A) and LiGL400-Cu∥NMC811 (FIG. 8B). FIG. 8C shows the sustainable capacity of bare Cu∥INMC811 and LiGL400-Cu∥NMC811 cells with cycling, showing that the LiGL400-Cul∥NMC811 enabled much higher capacities than those of the bare Cu∥NMC81 cell. FIG. 8D shows the Coulombic efficiency of bare Cu∥NMC811 and LiGL400-Cu∥NMC811 cells with cycling, showing that the LiGL400-Cu∥NMC811 enabled much higher Coulombic efficiencies than those of the bare Cu∥NMC81 cell. LiGL400 indicates 400 MLD cycles of LiGL.

FIGS. 9A-9D provide schematic illustrations of different Li∥Cu asymmetric cell configurations, including bare Li∥Cu (FIG. 9A), an Li_{LiGL}∥Cu cell, in which Li metal was coated by an LiGL film of 60 MLD cycles via MLD (FIG. 9B), an Li∥Cu_{LiGL} cell, in which Cu foil was coated by an LiGL film of 60 MLD cycles via MLD (FIG. 9C), and an Li_{LiGL}∥Cu_{LiGL} cell in which both Li and Cu foils were coated by an LiGL film of 60 MLD cycles via MLD (FIG. 9D).

FIG. 10 provides overpotential profiles of four cell configurations (bare Li∥Cu cell, Li_{LiGL}∥Cu cell, Li∥Cu_{LiGL} cell, and Li_{LiGL}∥Cu_{LiGL} cell) in the first 10 hours, in which the LiGL coating is 60 MLD cycles (~160 nm thick). The electrolyte is 1 M LiTFSI 1:1 DOL/DME.

FIG. 11 provides overpotential profiles of four cell configurations (bare Li∥Cu cell, Li_{LiGL}∥Cu cell, Li∥Cu_{LiGL} cell, and Li_{LiGL}∥Cu_{LiGL} cell) in the range of 50-60 hours, in which the LiGL coating is 60 MLD cycles (~160 nm thick). The electrolyte is 1 M LiTFSI 1:1 DOL/DME.

FIG. 12 provides overpotential profiles of four cell configurations (bare Li∥Cu cell, Li_{LiGL}∥Cu cell, Li∥CuLiGL cell, and Li_{LiGL}∥Cu_{LiGL} cell) in the range of 100-110 hours, in which the LiGL coating is 60 MLD cycles (~160 nm thick). The electrolyte is 1 M LiTFSI 1:1 DOL/DME.

FIG. 13 provides overpotential profiles of four cell configurations (bare Li∥Cu cell, Li_{LiG}∥Cu cell, Li∥Cu_{LiGL} cell, and Li_{LiGL}∥Cu_{LiGL} cell) in the range of 150-160 hours, in which the LiGL coating is 60 MLD cycles (~160 nm thick). The electrolyte is 1 M LiTFSI 1:1 DOL/DME.

FIG. 14 provides overpotential profiles of four cell configurations (bare Li∥Cu cell, Li_{LiGL}∥Cu cell, Li∥Cu_{LiGL} cell, and Li_{LiGL}∥Cu_{LiGL} cell) in the range of 200-210 hours, in which the LiGL coating is 60 MLD cycles (~160 nm thick). The electrolyte is 1 M LiTFSI 1:1 DOL/DME.

FIG. 15 provides overpotential profiles of four cell configurations (bare Li∥Cu cell, Li_{LiGL}∥Cu cell, Li∥Cu_{LiGL} cell, and Li_{LiGL}∥Cu_{LiGL} cell) in the range of 250-260 hours, in which the LiGL coating is 60 MLD cycles (~160 nm thick). The electrolyte is 1 M LiTFSI 1:1 DOL/DME.

FIG. 16 provides Coulombic efficiency of four cell configurations (bare Li∥Cu cell, Li_{LiGL}∥Cu cell, Li∥Cu_{LiGL} cell, and Li_{LiGL}∥Cu_{LiGL} cell) in the range of 0-300 hours, in which the LiGL coating is 60 MLD cycles (~160 nm thick). The electrolyte is 1 M LiTFSI 1:1 DOL/DME.

FIG. 17 provides the first charge-discharge profile of four cells (bare Cu∥NMC811 cell, LiHQ50-Li∥NMC811 cell, LiTEA30-Li∥NMC811 cell, and LiGL4-Li∥NMC811 cell) in the voltage window of 3-4.3 V and at a current density of 0.5 C (1 C=200 mA/g), in which LiHQ, LiTEA, and LiGL were coated for 50, 30, and 4 MLD cycles, respectively. The electrolyte is 1.2 M LiPF₆ in 3:7 EC/EMC.

FIG. 18 shows the cycling performance of four cells (bare Cu∥NMC811 cell, LiHQ50-Li∥NMC811 cell, LiTEA30-Li∥NMC811 cell, and LiGL4-Li∥NMC811 cell) in the voltage window of 3-4.3 V and at a current density of 0.5 C (1 C=200 mA/g) in which LiHQ, LiTEA, and LiGL were coated for 50, 30, and 4 MLD cycles, respectively. The electrolyte is 1.2 M LiPF₆ in 3:7 EC/EMC.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Since the commercialization of lithium-ion batteries (LIBs) in 1991, LIBs have dominated consumer portable electronics and recently have penetrated the market of electric vehicles. Typically, state-of-the-art LIBs adopt a lithiated metal oxide as the cathode and a graphite anode soaked in a liquid organic electrolyte. Many lithiated metal oxides have been investigated and commercialized in LIBs, such as LiCoO₂ (LCO), LiNiₓMn_{y}Co_{z}O₂ (x+y+z=1, NMCs), LiNiₓCo_{y}Al_{z}O₂ (x+y+z=1, NCAs), LiMn₂O₄ (LMO), and LiFePO₄ (LFP).

While LIBs are approaching their energy limits (less than 250 Wh/kg in the cylindrical cells and less than 300 Wh/kg in the pouch cells), new battery systems enabling higher energy density are urgently needed to support such continuous development. In this context, replacing the graphite anode of LIBs with lithium (Li) metal to couple with existing LIB cathodes is currently a promising technical strategy. The resultant lithium metal batteries (LMBs) promise a much higher energy density, up to 2 times higher than that of LIBs using the graphite anode, for Li metal enables an extremely high capacity of 3860 mAh/g, over ten times higher than that of the graphite anode (372 mAh/g). In addition, Li metal has the lowest redox potential, −3.04 V versus standard hydrogen electrode (SHE). In LMBs, Li is deposited on the anode side during a charge process while extracted from the anode side to the cathode side during a discharge process.

With the adoption of lithiated cathodes (e.g., LCO, NMCs, NCAs, LMO, LFP, and Li₂S), it is theoretically feasible for LMBs to fully utilize the total amount of Li stored in the cathodes without an addition of Li metal anodes but just leave the bare anode current collector (typically copper foils) on the anodic side. Such cell build-ups are so called anode-free LMBs (AF-LMBs), in which the amount of Li⁺ ions all originate from the lithiated cathodes.

Thus, AF-LMBs are initially in a fully discharged state and have no excess Li metal on the anodic side. Once they are charged, they will gain their Li metal anodes. Thus, AF-LMBs can exploit the full potential of the lithium-containing cathode system. Compared to traditional LMBs, AF-LMBs eliminate the excessive use of Li and save anode volume and weight, resulting in the highest volumetric and gravimetric energy density. On the other hand, removing the Li anode also reduces the cost of battery production and maintenance, enabling the lowest cost.

Furthermore, AF-LMBs also improve battery safety with no excessive Li and reduced electrolytes. Thus, AF-LMBs have great potentials as a next-generation battery technology over LIBs. They can greatly boost energy density, remarkably save costs, and evidently improve battery safety.

Although AF-LMBs are very promising, they face two main hurdles that hinder them from commercialization. First of all, one big issue is the continuous formation of solid electrolyte interphase (SEI) during Li plating. The SEI layer is the layer between Li metal and the liquid electrolyte. The SEI layer is the product due to the reaction of the Li metal with the liquid electrolyte. A stable SEI is critical to protect the liquid electrolyte and Li metal from consumption. Otherwise, the continuous formation of SEI will deplete Li metal and the electrolyte, leading to cell failure.

Additionally, Li deposition on the copper is uneven and leads to the dendritic growth. The Li dendrites are formed with a layer of SEI once they contact the liquid electrolyte. Lithium dendrites also pose safety issues, for they may grow into the cathode side and thereby short the cell with fire or explosion.

In particular, SEI formation and Li dendritic growth are interconnected and self-accelerated. Following an Li plating process, an Li stripping process produces lots of dead Li dispersed in the liquid electrolyte and an SEI layer on the Cu foil. In return, they are prone to aggravate SEI formation and Li dendritic growth in the following plating process.

As a consequence, the initial Li storage in the cathode is liable to deplete quickly in limited Li-plating-stripping cycles and the plating-stripping cycles exhibit a decreased Coulombic efficiency (CE).

To tackle these issues, many different strategies have been investigated to design new electrolytes and current collectors for improved electrochemical performance of AF-LMBs, in terms of Coulombic efficiency, capacity retention, and sustainable capacity. Numerous embodiments of the present disclosure address the aforementioned issues.

In some embodiments, the present disclosure pertains to an energy storage device with an anode current collector that includes a surface coating of a lithium metal sulfide, a lithium-containing alkoxide polymer, or combinations thereof. Additional embodiments of the present disclosure pertain to methods of making an energy storage device by depositing a surface coating of the present disclosure on an anode current collector of the energy storage device. In some embodiments, the methods of the present disclosure also include a step of incorporating the anode current collector into the energy storage device. As set forth in more detail herein, the energy storage devices and methods of the present disclosure can have various embodiments.

### Anode Current Collectors

The energy storage devices of the present disclosure can include various anode current collectors. Moreover, the methods of the present disclosure may deposit surface coatings on various anode current collectors.

For instance, in some embodiments, the anode current collector includes a copper foil. In some embodiments, the anode current collector is a component of a lithium∥copper (Li∥Cu) cell. In some embodiments, the anode current collector is included in a lithium∥copper (Li∥Cu) cell. In some embodiments, the surface coating is associated with the lithium surface of the Li∥Cu cell, the copper surface of the Li∥Cu cell, or combinations thereof. In some embodiments, the surface coating is associated with the lithium surface of the Li∥Cu cell. In some embodiments, the surface coating is associated with the copper surface of the Li∥Cu cell. In some embodiments, the surface coating is associated with the lithium surface and the copper surface of the Li∥Cu cell. In some embodiments, the cyclability and Coulombic efficiency of Li∥Cu cells (with or without a surface coating) can be used for evaluating the utilization efficiency of Li. A higher Coulombic efficiency means longer useability of a limited lithium and therefore a longer cyclability of Li∥Cu cells.

### Surface Coatings

The anode current collectors of the present disclosure may include various types of surface coatings. Moreover, the methods of the present disclosure may be utilized to deposit various types of surface coatings on anode current collectors.

For instance, in some embodiments, the surface coating is in the form of a uniform surface. In some embodiments, the surface coating prevents formation of a solid electrolyte interphase (SEI) between the anode current collector and an electrolyte. In some embodiments, the surface coating prevents the formation of dendrites on the anode current collector.

The methods of the present disclosure may utilize various processes to deposit surface coatings on anode current collectors. For instance, in some embodiments, the surface coating is deposited by a method that includes, without limitation, atomic layer deposition (ALD), molecular layer deposition (MLD), or combinations thereof.

In some embodiments, the depositing includes forming the surface coating directly on the anode current collector of the energy storage device. In some embodiments, the depositing includes associating a formed surface coating with the anode current collector of the energy storage device. For instance, in some embodiments, an ALD and/or MLD process may be utilized to form a surface coating. Thereafter, the formed surface coating is deposited on an anode current collector surface. In some embodiments, an ALD and/or MLD process may be utilized to form a surface coating directly on an anode current collector surface.

### Lithium Metal Sulfide-Based Surface Coatings

In some embodiments, the anode current collector surface coating includes lithium metal sulfides. In some embodiments, the lithium metal sulfides includes the formula LiₓM_{y}S, where M is a metal, and where x and y are each a decimal number or an integer number of more than 0. In some embodiments, M is Al, Zr, Zn, or Ga. In some embodiments, the lithium metal sulfides include, without limitation, LiₓAl_{y}S, LiₓZn_{y}S, LiₓZr_{y}S, LiₓGa_{y}S, or combinations thereof.

In some embodiments, the lithium metal sulfides have tunable compositions and properties. For instance, as coatings of anode current collectors, the lithium metal sulfides of the present disclosure can modify an anode current collector's surface properties to facilitate lithium deposition with minimal formation of SEI and minimal consumption of both electrolyte and cyclable lithium.

Lithium metal sulfides may be in various forms. For instance, in some embodiments, the lithium metal sulfide includes a plurality of stacked layers. In some embodiments, each layer includes the same lithium metal sulfide. In some embodiments, each layer includes a different lithium metal sulfide.

The methods of the present disclosure may utilize various processes to deposit lithium metal sulfide surface coatings on anode current collectors. For instance, in some embodiments, the lithium metal sulfide is formed through an atomic layer deposition (ALD) process that combines at least one lithium precursor, at least one sulfur precursor, and at least one metal precursor to form the lithium metal sulfide. In some embodiments, the combining steps are repeated a plurality of times in order to form a plurality stacked layers of lithium metal sulfides.

ALD processes may utilize various lithium precursors to form lithium metal sulfides. For instance, in some embodiments, the lithium precursor includes, without limitation, lithium tert-butoxide (LTB, LiO^{t}Bu), lithium hexamethyldisilazide (LiHMDS, Li(N(SiMe₃)₂), lithium trimethylsilanolate (LiTMSO, LiOSiMe₃), Li(2,2,6,6-tetramethyl-3,5-heptanedionate) (Li(thd)), or combinations thereof.

ALD processes may also utilize various sulfur precursors to form lithium metal sulfides. For instance, in some embodiments, the sulfur precursor includes, without limitation, H₂S, di-tert-butyl disulfide (TBDS), or combinations thereof.

ALD processes may also utilize various metal precursors to form lithium metal sulfides. For instance, in some embodiments, the metal precursor includes, without limitation, an aluminum precursor, tris(dimethylamido)aluminum (TDMA-Al), a zinc precursor, diethylzinc (DEZ), a zirconium precursor, tetraki(dimethylamido)zirconium (TDMA-Zr), a gallium precursor, tris(dimethylamido)gallium (TDMA-Ga), or combinations thereof.

### Lithium-Containing Alkoxide Polymer-Based Surface Coatings

In some embodiments, the anode current collector surface coating includes a lithium-containing alkoxide polymer. In some embodiments, the lithium-containing alkoxide polymer includes a lithium-containing alkoxide homopolymer. In some embodiments, the lithium-containing alkoxide polymer includes a lithium-containing alkoxide heteropolymer.

In some embodiments, the lithium-containing alkoxide polymer includes the following formula: —Li—O—R—O—Li—, where R is a carbon-containing compound. In some embodiments, R is derived from a carbon-containing compound that includes, without limitation, glycerol (GL), hydroquinone (HQ), ethylene glycol (EG), triethanolamine (TEA), or combinations thereof. In some embodiments, R is derived from glycerol (GL). In some embodiments, R is derived from hydroquinone (HQ). In some embodiments, R is derived from ethylene glycol (EG). In some embodiments, R is derived from triethanolamine (TEA).

Lithium-containing alkoxide polymers may be in various forms. For instance, in some embodiments, the lithium-containing alkoxide polymer includes a plurality of stacked layers. In some embodiments, each layer includes the same lithium-containing alkoxide polymer. In some embodiments, each layer includes a different lithium-containing alkoxide polymer.

The methods of the present disclosure may utilize various processes to deposit lithium-containing alkoxide polymer surface coatings on anode current collectors. For instance, in some embodiments, the lithium-containing alkoxide polymer is formed by combining at least one lithium source with at least one hydroxyl group-containing organic precursor through molecular layer deposition (MLD). In some embodiments, the combining steps are repeated a plurality of times in order to form a plurality stacked layers of lithium-containing alkoxide polymers.

MLD process may utilize various lithium sources. For instance, in some embodiments, the Li source includes, without limitation, lithium tert-butoxide (LTB, LiO^{t}Bu), lithium hexamethyldisilazide (LiHMDS, Li(N(SiMe₃)₂), lithium trimethylsilanolate (LiTMSO, LiOSiMe₃), Li(2,2,6,6-tetramethyl-3,5-heptanedionate) (Li(thd)), or combinations thereof, MLD process may utilize various hydroxyl-group containing organic precursors. For instance, in some embodiments, the hydroxyl group-containing organic precursor includes, without limitation, diols, triols, polyols, hydroquinone (HQ), tetrafluorohydroquinone (FHQ), 1,4-benzenedicarboxylic acid (BDC), 2,6-naphthalene dicarboxylic acid (NDC), ethylene glycol (EG), 1,2-ethanediol (EDO), 1,4-butanediol (BDO), 1,6-hexanediole (HDO), fumaric acid (FC), 2,4-hexadiyene-1,6-diol (HDD), 1,2,4-trihydroxybenzene (THB), glycerol (GL), triethanolamine (TEA), lactic acid (LC), 2,2-bis(hydroxymethyl)-1,3-propanediole (BHMPD), alpha-thioglycerol (TGL), 1,2,4-butanetriol (BT), 1,2,5,6-hexanetriol (HT), 2-hydroxymethyl-1,3-propanediol (HMPD), 1-(4-nitrophenyl)glycerol (NPGL), or combinations thereof.

### Energy Storage Devices

The energy storage devices of the present disclosure may be in various forms. Additionally, the methods of the present disclosure may be utilized to form various types of energy storage devices.

For instance, in some embodiments, the energy storage device is an anode-free energy storage device. In some embodiments, the energy storage device is a battery. In some embodiments, the energy storage device is a lithium-ion battery. In some embodiments, the energy storage device is a lithium metal battery. In some embodiments, the energy storage device is an anode-free lithium metal battery.

### Cathodes

In some embodiments, the energy storage devices of the present disclosure may include cathodes. In some embodiments, the cathode is a lithiated cathode. In some embodiments, the lithiated cathode includes, without limitation, lithiated metal oxide, LiCoO₂ (LCO), LiNiₓMn_{y}Co_{z}O₂ (x+y+z=1, NMCs), LiNiₓCo_{y}Al_{z}O₂ (x+y+z=1, NCAs), LiMn₂O₄ (LMO), LiFePO₄ (LFP), Li₂S, or combinations thereof.

In some embodiments, the energy storage devices of the present disclosure may also include cathode current collectors.

### Electrolytes

In some embodiments, the energy storage devices of the present disclosure may also include an electrolyte. In some embodiments, the surface coating is positioned between the anode current collector and the electrolyte.

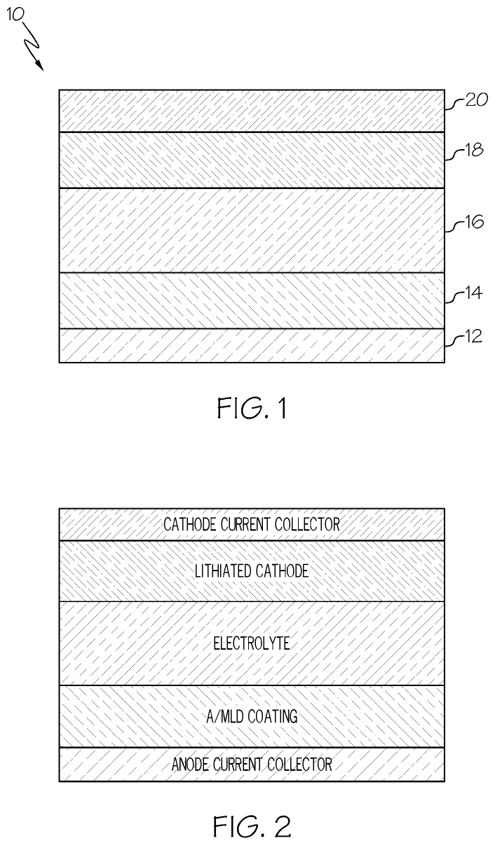

The energy storage devices of the present disclosure may include various architectures. For instance, in some embodiments, energy storage devices of the present disclosure are in the form of energy storage device 10 illustrated in FIG. 1. In this example, energy storage device 10 includes anode current collector 12, surface coating 14, electrolyte 16, cathode 18, and cathode current collector 20. In this example, surface coating 14 is positioned between anode current collector 12 and electrolyte 16.

### Additional Embodiments

Reference will now be made to more specific embodiments of the present disclosure and experimental results that provide support for such embodiments. However, applicant notes that the disclosure below is for illustrative purposes only and is not intended to limit the scope of the claimed subject matter in any way.

### Example 1

### Formation of Anode-Free Lithium Metal Batteries

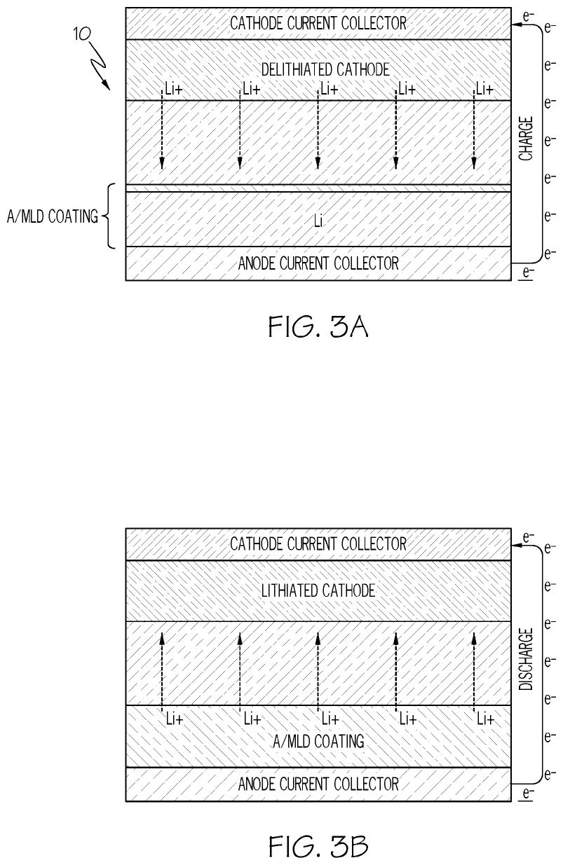

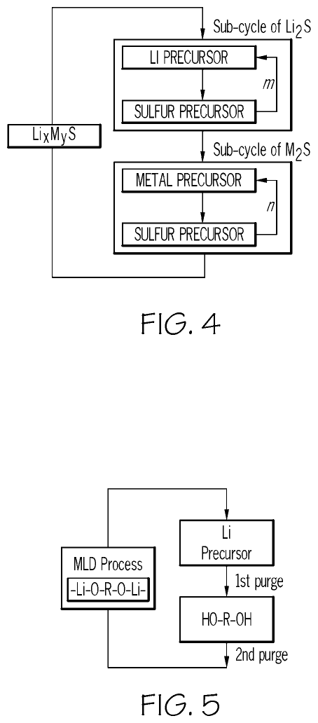

In this Example, Applicant describes the development of anode-free lithium metal batteries (AF-LMBs) through applying new surface coatings over anode current collectors (ACC, e.g., copper foils) via atomic or/and molecular layer deposition (A/MLD) (FIG. 2). The A/MLD-coated ACC is used to couple with a lithiated cathode on a cathode current collector (CCC) to form an AF-LMB cell. An electrolyte is located between them to facilitate the transport of Li⁺ ions during charge and discharge processes. The cell is initially in a discharge state and, thus, a charge process is needed to functionalize it. During a charge process (FIG. 3A), Li⁺ ions are transferred from the lithiated cathode to the A/MLD-coated ACC via the electrolyte while electrons move in the same direction by taking an external circuit. The Li⁺ ions and electrons meet on the ACC surface to form Li metal and grow thicker with the continuous deposition. The A/MLD coating ensures that there is no SEI formation and Li dendritic growth through uniformizing the ACC surface and protecting the deposited Li from contacting with the electrolyte. The A/MLD coating can accommodate all the deposited Li layer (FIG. 3A).

In a following discharge process (FIG. 3B), Li⁺ ions are transferred back to the cathodic side while electrons move back in the same direction by taking the externa circuit. They meet at the cathodic side and recover the delithiated cathode into its lithiation state.

In this Example, the A/MLD coating is inorganic, organic, or a hybrid inorganic-organic composite. The coating has a high ionic conductivity and low electrical conductivity.

### Example 1.1

### Fabrication of Lithiated Cathode Materials

Lithiated cathode materials as active materials are commercially available, including but not limited to layered LiCoO₂ (LCO), layered LiNiₓMn_{y}Co_{z}O₂ (NMCs, x+y+z=1), spinel Li₂Mn₂O₄, spinel Li₂Ni_{0.5}Mn_{1.5}O₄, olivine LiFePO₄, and Li₂S.

### Example 1.2

### Fabrication of Lithiated Cathodes

A general procedure to fabricate a lithiated cathode is as follows. Lithiated cathode materials as active materials are added with a conductive additive (e.g., carbon black) and a binder (e.g., polyvinylidene fluoride (PVDF)) in a certain ratio and fully mixed in a solvent (e.g., N-Methyl-2-pyrrolidone (NMP)) for a sufficient time. The resultant homogenous slurry is cast on a cathode current collector (e.g., aluminum foil (Al)) and dried to remove NMP away. The resultant cathode is further dried in vacuum at 80-120° C. thoroughly before it is tested in a cell. Described herein are a few of lithiated cathodes produced.

### Example 1.2.1

### Fabrication of LiNi_{0.6}Mn_{0.2}Co_{0.2}O₂ (NMC622) Cathodes

Commercial micro-sized NMC622 powders are mixed with carbon black and PVDF in a ratio of 8:1:1 in NMP sufficiently. The resultant homogenous slurry is cast on Al foil using a doctor blade. The resultant laminate is dried overnight in air and then placed in a vacuum oven at 100° C. to further dry for 10 hours in argon (Ar).

### Example 1.2.2

### Fabrication of LiNi_{0.8}Mn_{0.1}Co_{0.1}O₂ (NMC811) cathodes

Commercial microsized NMC811 powders are mixed with carbon black and PVDF in a ratio of 86:7:7 in NMP sufficiently. The resultant homogenous slurry is cast on Al foil using a doctor blade. The resultant laminate is dried overnight in air and then placed in a vacuum oven at 100° C. to further dry for 10 hours in Ar.

### Example 1.2.3

### Fabrication of LifePO₄ (LFP) Cathodes

Commercial microsized LFP powders are mixed with carbon black and PVDF in a ratio of 80:10:10 in NMP sufficiently. The resultant homogenous slurry is cast on Al foil using a doctor blade. The resultant laminate is dried overnight in air and then placed in a vacuum oven at 100° C. to further dry for 10 hours in Ar.

### 1.2.4

### Fabrication of Li₂S Cathodes

Sealed in Ar, commercial nanosized Li₂S powders are mixed with carbon black and PVDF in a ratio of 60:30:10 in NMP sufficiently. The resultant homogenous slurry is cast on Al foil using a doctor blade in Ar. The resultant laminate is dried overnight in Ar and then placed in a vacuum oven at 100° C. to further dry for 10 hours in Ar.

### Example 1.3

### Fabrication of A/MLD Coatings

Described herein are the fabrication of anode current collector coatings through atomic layer deposition (ALD) and molecular layer deposition (MLD). Such coatings are referred to herein as A/MLD coatings.

### Example 1.3.1

### Inorganic Superionic Conductor Coatings via ALD

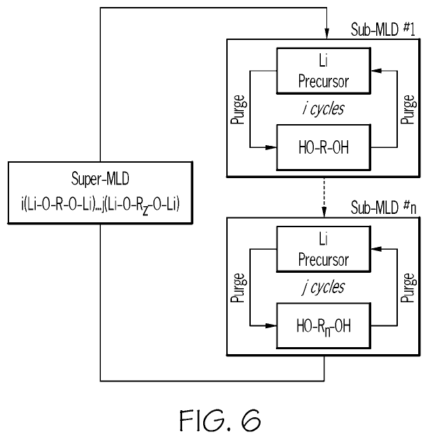

In this Example, the inorganic superionic conductors are lithium metal sulfides (LiₓM_{y}S, M=metals), such as LiₓAl_{y}S, LiₓZn_{y}S, LiₓZr_{y}S, and LiₓGa_{y}S. They are grown in an accurately tunable mode via super-ALD processes (FIG. 4). In this super-ALD strategy, a binary sub-ALD process of lithium sulfide (LiₓS) is integrated with a binary sub-ALD process of M_{z}S (0<Z≤2) to form a super-ALD process. In the sub-ALD process of Li₂S, one Li precursor is coupled with one sulfur precursor to grow LiₛS.

The Li precursors include, without limitation, lithium tert-butoxide (LTB, LiOtBu), lithium hexamethyldisilazide [LiHMDS, Li(N(SiMe3)2)], lithium trimethylsilanolate (LiTMSO, LiOSiMe₃), and Li(thd) (thd=2,2,6,6-tetramethyl-3,5-heptanedionate). The sulfur precursors include, without limitation, H₂S and di-tert-butyl disulfide (TBDS). The metal precursors include, without limitation, tris(dimethylamido)aluminum (TDMA-Al), diethylzinc (DEZ), tetraki(dimethylamido)zirconium (TDMA-Zr), and tris(dimethylamido)gallium (TDMA-Ga).

Through adjusting the ratio of the sub-cycles (m) of the sub-ALD-Li₂S and the sub-cycles (n) of the sub-ALD-MzS, the resultant super-ALD processes can produce a variety of LiₓM_{y}S with tunable compositions and tunable electrical and ionic conductivities.

### Example 1.3.2

### Organic Superionic Conductor Coatings via MLD

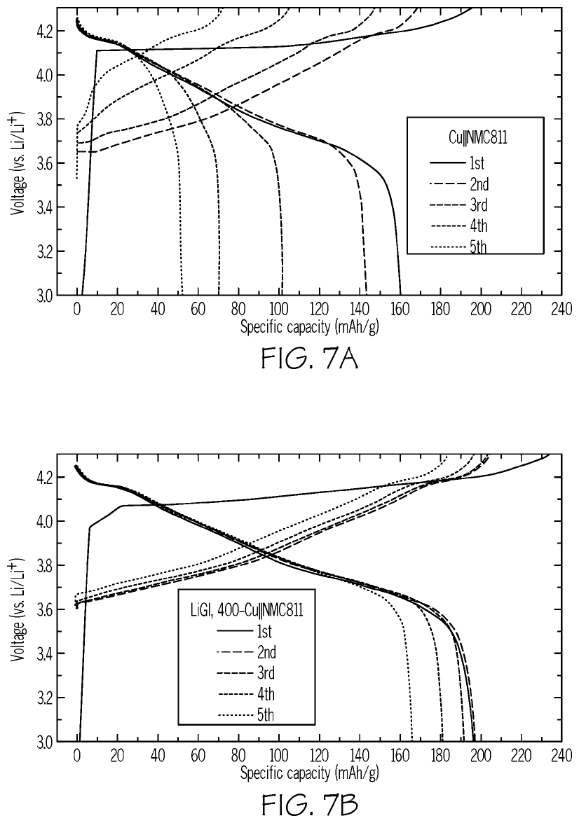

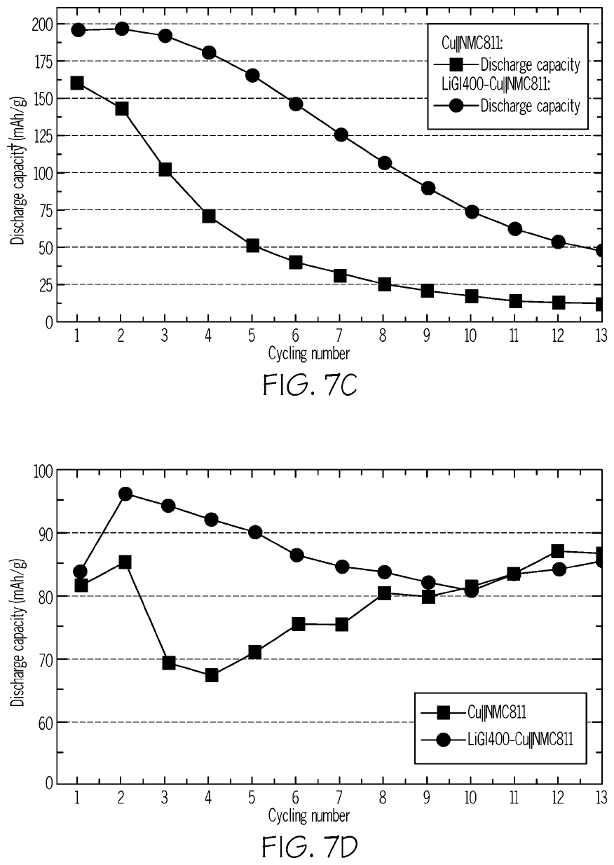

In this Example, the organic superionic conductors are homopolymers of Li-containing alkoxides (homoalkoxides) or copolymers of Li-containing alkoxides (co-alkoxides). The Li-containing homo-alkoxides are LiGL (GL=glycerol), LiHQ (HQ=hydroquinone), LiEG (EG=ethylene glycol), and LITEA (TEA=triethanolamine) via MLD, but not limited to them (FIG. 5). The Li-containing co-alkoxides are those produced through combining two (FIG. 6) or more different Li-containing homo-alkoxides via super-MLD processes. They all are hybrid polymers having carbon-containing backbones, i.e., —Li—O—R—O—Li—, where R is used in these molecular structures to represent the “Rest of the molecule”. R consists of a group of carbon and hydrogen atoms of any size.

The Li precursors include, without limitation, lithium tert-butoxide (LTB, LiOtBu), lithium hexamethyldisilazide [LiHMDS, Li(N(SiMe₃)₂)], lithium trimethylsilanolate (LiTMSO, LiOSiMe₃), and Li(thd) (thd=2,2,6,6-tetramethyl-3,5-heptanedionate). The organic precursors include, without limitation, GL, HQ, EG, and TEA to couple with the Li precursors (FIG. 5).

FIG. 6 illustrates the super-MLD process to combine two or more sub-MLD processes of Li-containing homoalkoxides for Li-containing co-alkoxides. These resultant Li-containing homo-alkoxides and coalkoxides serve as organic superionic conductor coatings in this Example, which are coated on the anode current collector.

### Example 1.3.3

### Hybrid Organic-Inorganic Superionic Conductor Coatings via A-MLD

In this Example, hybrid organic-inorganic superionic conductor coatings are produced through integrating one or more organic superionic conductor coatings via MLD and one or more inorganic superionic conductor coatings via ALD together. This A-MLD integration strategy provides unlimited opportunities to develop novel exceptional coatings applied on the anode current collector.

### Example 1.4

### Electrochemical Tests

To demonstrate the effects of Applicant's A/MLD coatings on AF-LMBs, Applicant deposited A/MLD coatings on Cu foil and used the resultant A/MLD-coated Cu foils to couple with lithiated cathodes. The resultant A/MLD-coated Cu∥lithiated cathode AF-LMB cells were compared with bare Cu∥lithiated cathode AF-LMB cells, in terms of their sustainable capacity and Coulombic efficiency.

Two liquid organic electrolytes were used: (1) one carbonate electrolyte: 1.2 M LiPF₆ in ethylene carbonate (EC)/ethylmethyl carbonate (EMC) (3:7 by weight) and (2) one ether electrolyte: 1 M bis(trifluoromethane)sulfonamide lithium salt (LiITFSI) in 1,3-dioxolane (DOL) and 1,2-dimethoxyethane (DME) (1:1, v/v).

One type of AF-LMB cells is Cu∥NMC811, in which Cu is either bare or coated by A/MLD. All Cu∥NMC811 cells were tested in the voltage window of 3.0-4.3 V at 0.2 C (1 C=200 mA/g). One type of AF-LMB cells is Cu∥LFP, in which Cu is either bare or coated by A/MLD. All Cu∥LFP cells were tested in the voltage window of 2.5-4.3 V at 0.2 C (1 C=170 mA/g).

One type of AF-LMB cells is Cu∥Li₂S, in which Cu is either bare or coated by A/MLD. All Cu∥Li₂S were tested in the voltage window of 1.6-3.0 V at 0.2 C (1 C=1166 mA/g).

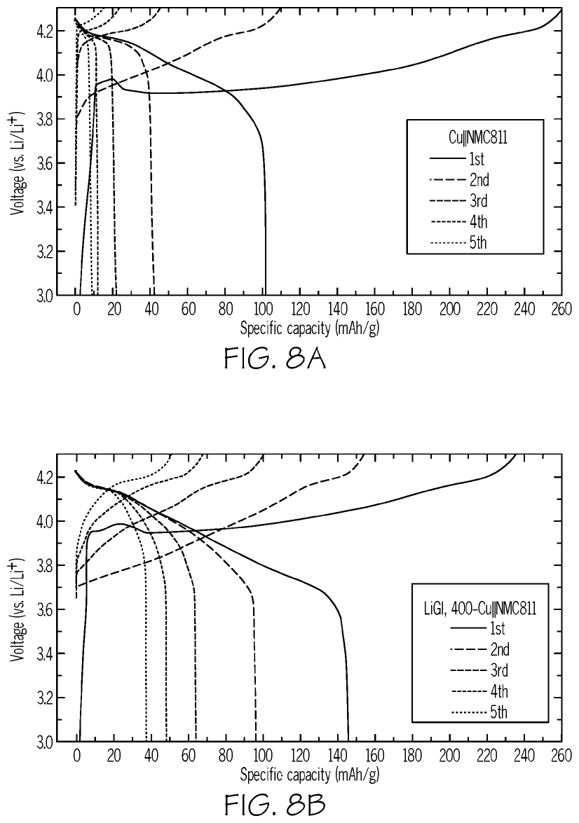

Applicant used LiGL coating via MLD to coat Cu foil and used the LiGL-coated Cu foil to couple with an NMC811 cathode. The resultant LiGL-coated Cu∥NMC811 AF-LMB cells showed dramatically improved sustainable capacities and Coulombic efficiencies with charge-discharge cycles. As shown in FIGS. 7A-7D, 400-MLD-cycle LiGL-coated Cu foil (LiGL400-Cu) was produced and compared with bare Cu foil used in Cu∥NMC811 AF-LMB cells. In the carbonate electrolyte of 1.2 M LiPFs in 3:7 EC: EMC, evidently, the LiGL 400-Cu∥NMC811 (FIG. 7B) enabled much more stable and higher charge-discharge capacities than those of the bare Cu∥NMC811 cell (FIG. 7A) in the first 5 charge-discharge cycles.

The discharge capacities of the two cells were further compared for more cycles in FIG. 7C, showing that the LiGL400-Cu∥NMC811 enabled much higher capacities than those of the bare Cu∥NMC811 cell. FIG. 7D further illustrates that the Coulombic efficiencies of the LiGL400-Cu∥NMC811 are much higher than those of the bare Cu∥NMC811 cell.

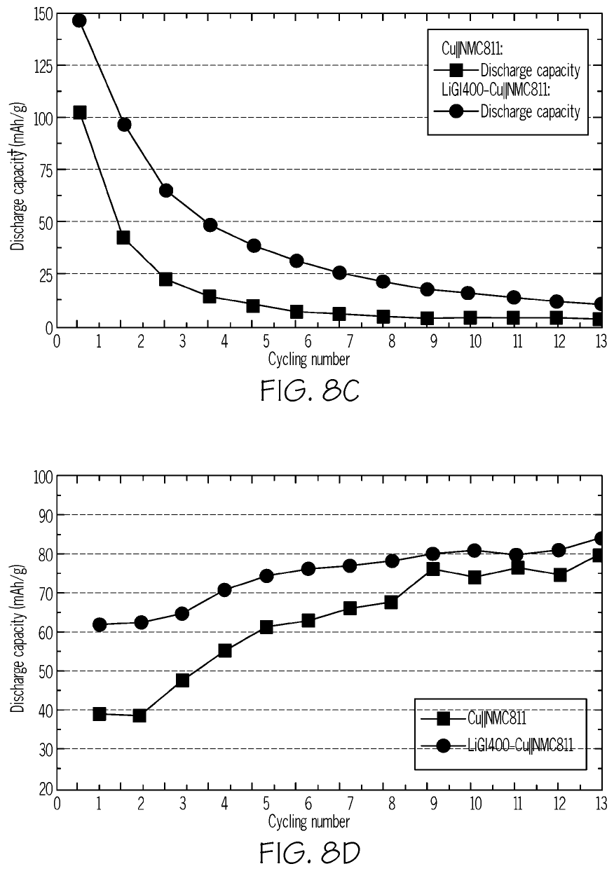

Similarly, consistent results were produced using the ether electrolyte of 1 M LiTFSI in 1:1 DOL: DME, as shown in FIGS. 8A-8D. These results revealed that the MLD LiGL coating is very promising to coat anode current collectors for developing AF-LMBs. The MLD LiGL coating can accommodate Li deposited on the anode current collectors and protect the deposited Li from corrosion through reacting with electrolytes and growing into dendritic structures.

### Example 2

### Characterization of Li∥Cu Asymmetric Cells with LiGL

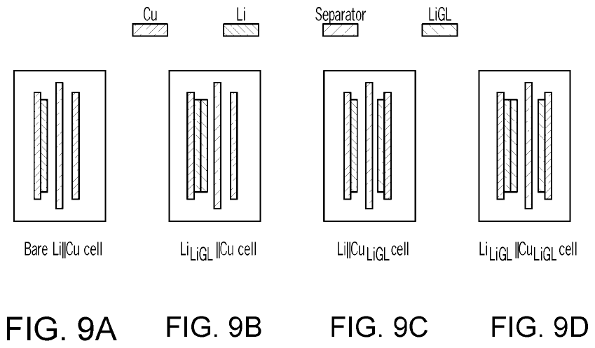

The effects of LiGL on Cu foil were investigated in Li∥Cu asymmetric cells and 4 cell configurations were studied (FIGS. 9A-9D). Such configurations included bare Li∥Cu cells (FIG. 9A), Li_{LiGL}∥Cu cells (FIG. 9B), Li∥Cu_{LiGL} cells (FIG. 9C), and Li_{LiGL}∥Cu_{LiGL} cells (FIG. 9D), in which Li_{LiGL} and Cu_{LiGL} are Li foil and Cu foil coated by LiGL, respectively. A liquid electrolyte was filled in these cells.

Applicant conducted Li-platting/stripping cycling to test the effects of LiGL coatings on Li foil and Cu foil. The liquid electrolyte is 1 M 1:1 DOL/DME. First, Li was deposited from Li or Li_{LiGL} on Cu or Cu_{LiGL} for 30 minutes at a current density of 2 mA/cm² and an areal capacity of 1 mAh/cm². This process is called Li-plating. Then, the deposited Li on Cu or Cu_{LiGL} was extracted and re-deposited on Li or Li_{LiGL} at a current density of 2 mA/cm². This process is called Li-stripping. The Li-stripping was controlled by pre-setting an overpotential of 1 V. Once the cell overpotential (voltage) was equal or higher than 1 V, the stripping stopped.

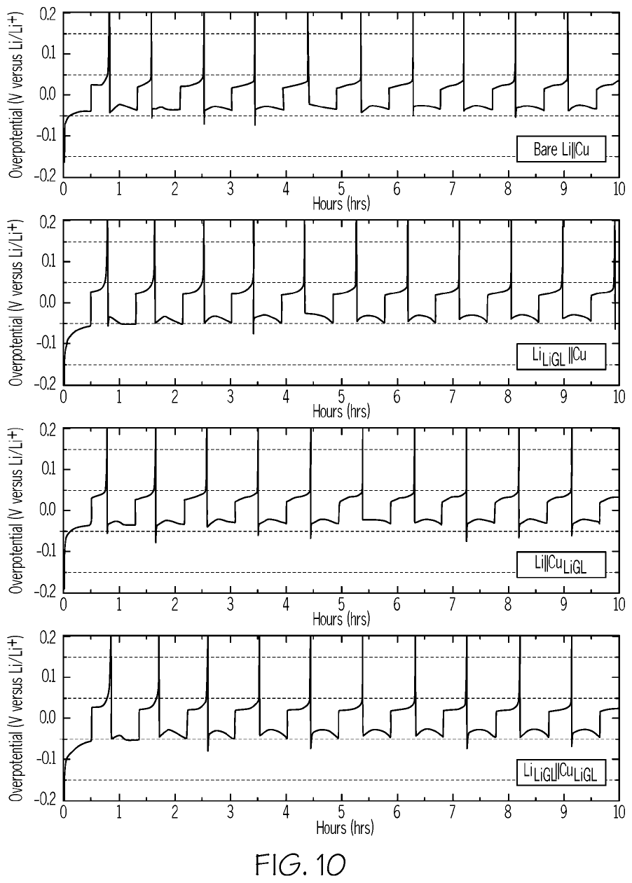

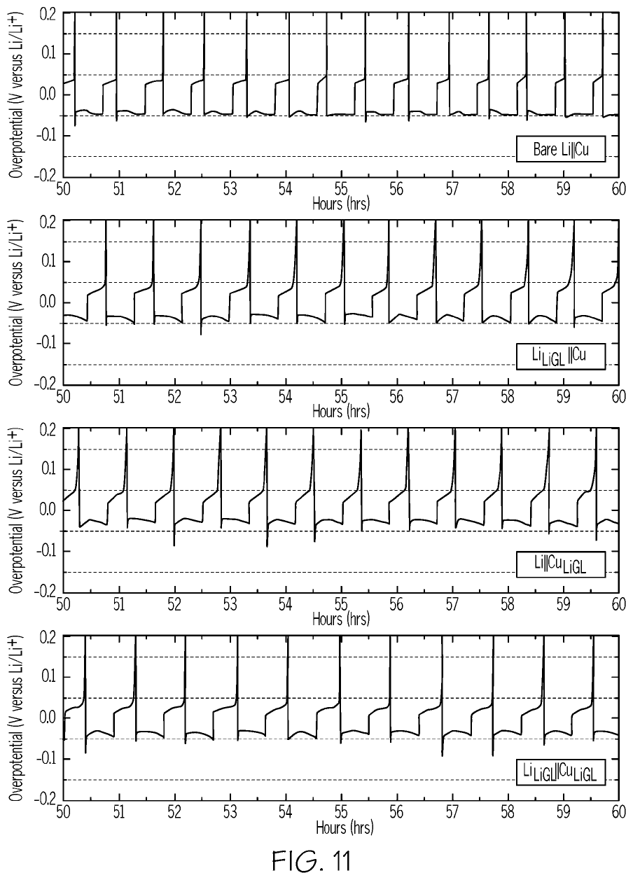

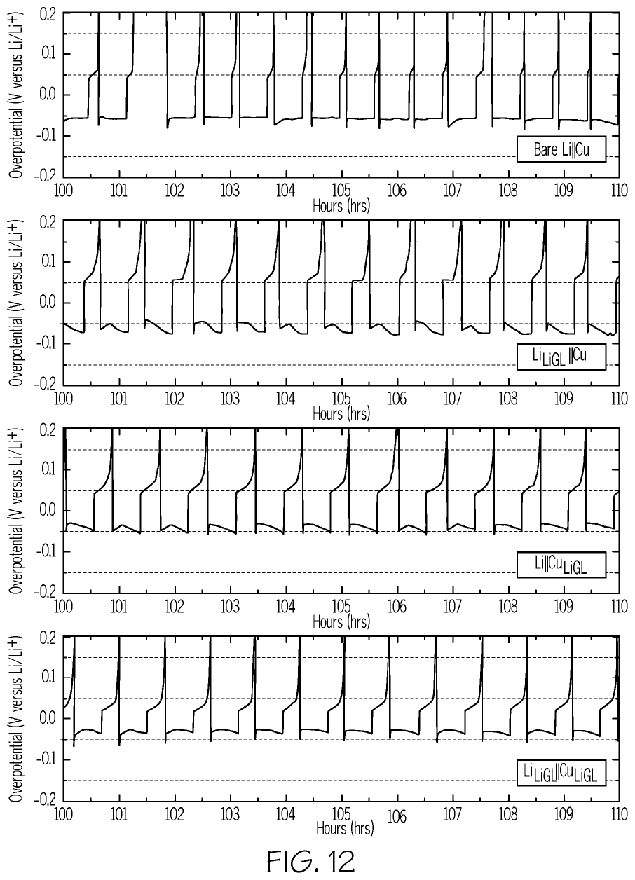

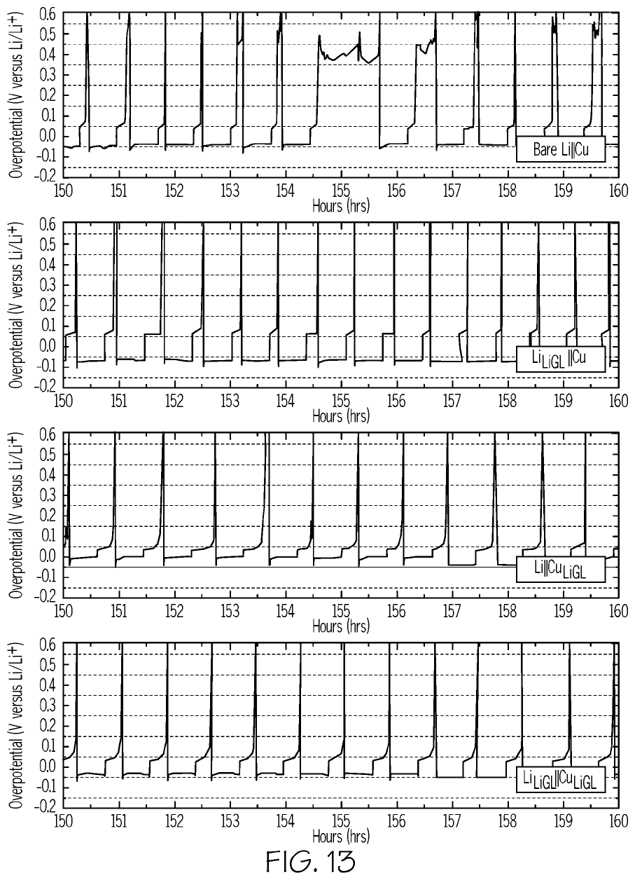

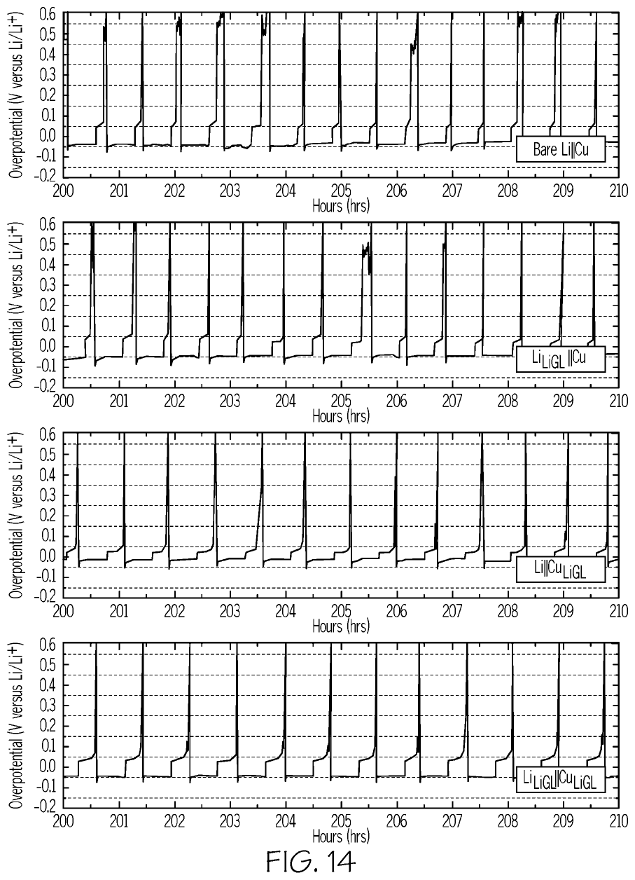

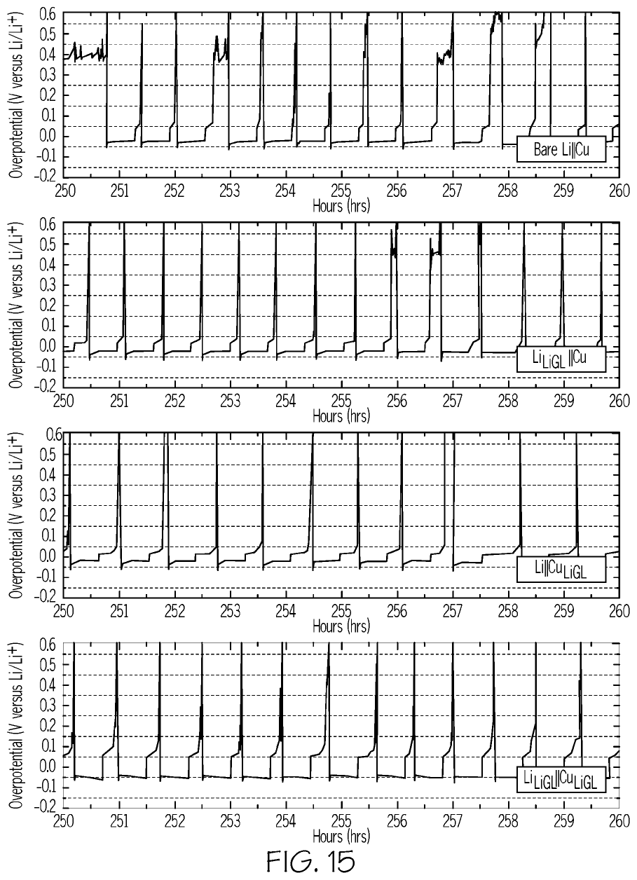

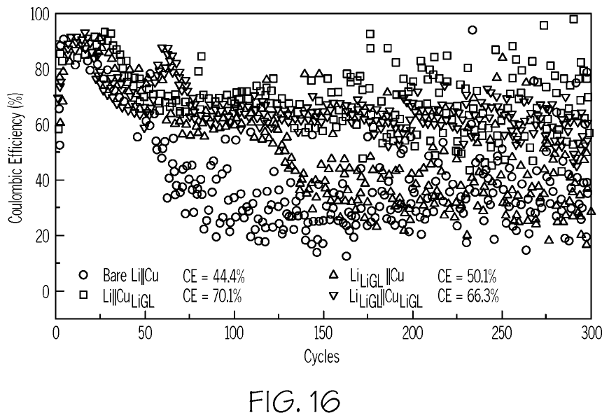

The time ratio of stripping time/plating time is the cell Coulombic efficiency. Applicant conducted the Li-plating/stripping for several hundreds of cycles to observe these cells' evolutions of voltage profiles, as shown in FIGS. 10-15. It can be observed from the overpotential profiles of these cells that the Li_{LiGL}∥Cu_{LiGL} cell is the most stable one, followed by Li∥Cu_{LiGL} cell, Li_{LiGL}∥Cu cell, and bare Li∥Cu cell. On one hand, apparently, the LiGL coating can protect pristine Li sheet from SEI formation and Li dendritic growth. On the other hand, the LiGL coating on Cu foil can help tune the surface property of Cu foil to inhibit the formation of both SEI and Li-dendrites. This could be further observed from FIG. 16, in which the evolutions of the CEs of these cells are comparatively shown. Evidently, both Li_{LiGL}∥Cu_{LiGL} and Li∥Cu_{LiGL} cells are comparable in CE stability and sustainable CE and much better than the other cells, while Li_{LiGL}∥Cu cell is better than the bare Li∥Cu cell. The sustainable CEs are 66.3, 70.1, 50.1, and 44.4% for the cells of Li_{LiGL}∥Cu_{LiGL}, Li∥Cu_{LiGL}, Li_{LiGL}∥Cu, and bare Li∥Cu cell.

As such, the LiGL coating on Cu foil enables an improvement of up to 25%. This strongly suggests that the LiGL coating is very encouraging for developing anode-free LMB cells.

### Example 2.1

### Testing of Cu∥NMC811 Anode-Free Cells

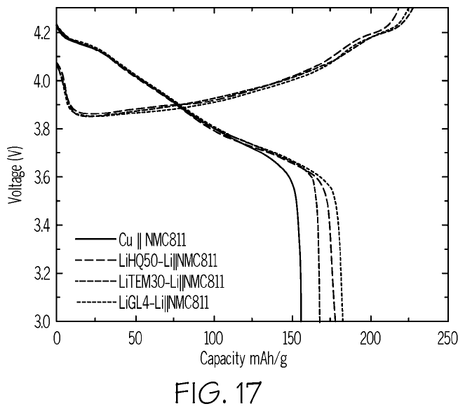

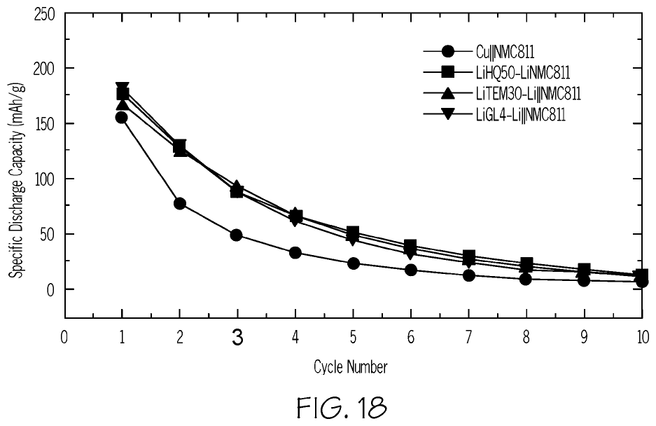

In addition to the LiGL coating, Applicant also verified the effects of LiHQ (HQ=hydroquinone) and LiTEA (TEA=triethanolamine) coatings via MLD on Cu∥NMC811 cells. As shown in FIG. 17, the MLD coatings (LiHQ, LiTEA, and LiGL) helped improve the first discharge capacity at 0.5 C (1 C=200 mA/g). FIG. 18 further shows that these MLD coatings (LiHQ, LiTEA, and LiGL) helped improve the sustainable capacities. In other words, these coatings enabled better utilization of Li-ions stored in NMC811. Such observations are significant for developing anode-free LMBs.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated hercin by reference, to the extent that they provide procedural or other details consistent with and supplementary to those set forth herein

What is claimed is:

1. An energy storage device comprising an anode current collector, wherein the anode current collector comprises a surface coating, wherein the surface coating is selected from the group consisting of a lithium metal sulfide, a lithium-containing alkoxide polymer, or combinations thereof.

2. The energy storage device of claim 1, wherein the anode current collector comprises a copper foil.

3. The energy storage device of claim 1, wherein the anode current collector is a component of a lithium∥copper (Li∥Cu) cell, wherein the surface coating is associated with the lithium surface, the copper surface, or combinations thereof.

4. The energy storage device of claim 1, wherein the surface coating comprises lithium metal sulfide comprising a plurality of stacked layers.

5. The energy storage device of claim 4, wherein the lithium metal sulfide comprises the formula LiₓM_{y}S, wherein M is a metal, and wherein x and y are each a decimal number or an integer number of more than 0.

6. The energy storage device of claim 5, wherein M is Al, Zr, Zn, or Ga.

7. (canceled)

8. The energy storage device of claim 4, wherein each layer comprises the same lithium metal sulfide.

9. The energy storage device of claim 4, wherein each layer comprises a different lithium metal sulfide.

10. The energy storage device of claim 1, wherein the surface coating comprises a lithium-containing alkoxide polymer comprising a plurality of stacked layers, wherein the lithium-containing alkoxide polymer comprises the following formula: —Li—O—R—O—Li—, wherein R is a carbon-containing compound.

11. (canceled)

12. The energy storage device of claim 10, wherein R is derived from a carbon-containing compound selected from the group consisting of glycerol (GL), hydroquinone (HQ), ethylene glycol (EG), triethanolamine (TEA), or combinations thereof.

13. (canceled)

14. The energy storage device of claim 10, wherein each layer comprises the same lithium-containing alkoxide polymer.

15. The energy storage device of claim 10, wherein each layer comprises a different lithium-containing alkoxide polymer.

16. The energy storage device of claim 1, wherein the energy storage device is an anode-free lithium metal battery.

17. The energy storage device of claim 1, further comprising a cathode, wherein the cathode is a lithiated cathode selected from the group consisting of lithiated metal oxide, LiCoO₂ (LCO), LiNiₓMn_{y}Co_{z}O₂ (x+y+z=1, NMCs), LiNiₓCo_{y}Al_{z}O2 (x+y+z=1, NCAs), LiMn₂O₄ (LMO), LiFePO₄ (LFP), Li₂S, or combinations thereof.

18. (canceled)

19. The energy storage device of claim 1, wherein the surface coating is positioned between the anode current collector and an electrolyte.

20. A method of making an energy storage device, said method comprising:
depositing a surface coating on an anode current collector, wherein the surface coating is selected from the group consisting of a lithium metal sulfide, a lithium-containing alkoxide polymer, or combinations thereof; and
incorporating the anode current collector into the energy storage device.

21. The method of claim 20, wherein the anode current collector comprises a copper foil.

22. The method of claim 20, wherein the anode current collector is a component of a lithium∥copper (Li∥Cu) cell, wherein the surface coating is deposited on the lithium surface, the copper surface, or combinations thereof.

23. The method of claim 20, wherein the depositing comprises forming the surface coating on the anode current collector of the energy storage device.

24. The method of claim 20, wherein the depositing comprises associating a formed surface coating with the anode current collector of the energy storage device.

25. The method of claim 20, wherein the surface coating is deposited by a method selected from the group consisting of atomic layer deposition (ALD), molecular layer deposition (MLD), or combinations thereof.

26. The method of claim 20, wherein the surface coating comprises lithium metal sulfide.

27. The method of claim 26, wherein the lithium metal sulfide comprises the formula LiₓM_{y}S, wherein M is a metal, and wherein x and y are each a decimal number or an integer number of more than 0.

28. The method of claim 26, wherein M is Al, Zr, Zn, or Ga.

29. The method of claim 26, wherein the lithium metal sulfide is formed through an atomic layer deposition (ALD) process that combines at least one lithium precursor, at least one sulfur precursor, and at least one metal precursor to form the lithium metal sulfide, and wherein the combining is repeated a plurality of times to form a plurality of stacked layers of lithium metal sulfide.

30. The method of claim 29,
wherein the lithium precursor is selected from the group consisting of lithium tert-butoxide (LTB, LiO^{t}Bu), lithium hexamethyldisilazide (LiHMDS, Li(N(SiMe₃)₂), lithium trimethylsilanolate (LiTMSO, LiOSiMe₃), Li(2,2,6,6-tetramethyl-3,5-heptanedionate) (Li(thd)), or combinations thereof;
wherein the sulfur precursor is selected from the group consisting of H₂S, di-tert-butyl disulfide (TBDS), or combinations thereof; and
wherein the metal precursor is selected from the group consisting of an aluminum precursor, tris(dimethylamido)aluminum (TDMA-Al), a zinc precursor, diethylzinc (DEZ), a zirconium precursor, tetraki(dimethylamido)zirconium (TDMA-Zr), a gallium precursor, tris(dimethylamido)gallium (TDMA-Ga), or combinations thereof.

31-33. (canceled)

34. The method of claim 20, wherein the surface coating comprises a lithium-containing alkoxide polymer.

35. The method of claim 34, wherein the lithium-containing alkoxide polymer comprises the following formula: —Li—O—R—O—Li—, wherein R is a carbon-containing compound.

36. The method of claim 35, wherein R is derived from a carbon-containing compound selected from the group consisting of glycerol (GL), hydroquinone (HQ), ethylene glycol (EG), triethanolamine (TEA), or combinations thereof.

37. The method of claim 34, wherein the lithium-containing alkoxide polymer is formed by combining at least one lithium source with at least one hydroxyl group-containing organic precursor through molecular layer deposition (MLD),
wherein the combining is repeated a plurality of times to form a plurality of stacked layers of lithium-containing alkoxide polymer
wherein the Lithium source is selected from the group consisting of lithium tert-butoxide (LTB, LiO^{t}Bu), lithium hexamethyldisilazide (LiHMDS, Li(N(SiMe₃)₂), lithium trimethylsilanolate (LiTMSO, LiOSiMe₃), Li(2,2,6,6-tetramethyl-3,5-heptanedionate) (Li(thd)), or combinations thereof,
wherein the hydroxyl group-containing organic precursor is selected from the group consisting of diols, triols, polyols, hydroquinone (HQ), tetrafluorohydroquinone (FHQ), 1,4-benzenedicarboxylic acid (BDC), 2,6-naphthalene dicarboxylic acid (NDC), ethylene glycol (EG), 1,2-ethanediol (EDO), 1,4-butanediol (BDO), 1,6-hexanediole (HDO), fumaric acid (FC), 2,4-hexadiyene-1,6-diol (HDD), 1,2,4-trihydroxybenzene (THB), glycerol (GL), triethanolamine (TEA), lactic acid (LC), 2,2-bis(hydroxymethyl)-1,3-propanediole (BHMPD), alpha-thioglycerol (TGL), 1,2,4-butanetriol (BT), 1,2,5,6-hexanetriol (HT), 2-hydroxymethyl-1,3-propanediol (HMPD), 1-(4-nitrophenyl)glycerol (NPGL), or combinations thereof.

38-40. (canceled)

41. The method of claim 20, wherein the energy storage device is an anode-free lithium metal battery.

42. The method of claim 20, wherein the energy storage device further comprises a cathode, wherein the cathode is a lithiated cathode selected from the group consisting of lithiated metal oxide, LiCoO₂ (LCO), LiNiₓMn_{y}Co_{z}O₂ (x+y+z=1, NMCs), LiNiₓCo_{y}Al_{z}O₂ (x+y+z=1, NCAs), LiMn₂O₄ (LMO), LiFePO₄ (LFP), Li₂S, or combinations thereof.

43. (canceled)

44. The method of claim 20, wherein the surface coating becomes positioned between the anode current collector and an electrolyte.
